(19) United States
(12) Patent Application Publication
(10) Pub. No.: US 2014/0367535 A1
(43) Pub. Date: Dec. 18, 2014

(54) Electronic Device Mounting Assembly

(71) Applicant: ReadyAction, LLC, Pittsburgh, PA (US)

(72) Inventors: David ROST, Pittsburgh, PA (US); Tim ROWE, Pittsburgh, PA (US)

(21) Appl. No.: 14/304,427

(22) Filed: Jun. 13, 2014

Related U.S. Application Data
(60) Provisional application No. 61/834,932, filed on Jun. 14, 2013.

(51) Int. Cl. F16M 11/10

(52) U.S. Cl. CPC F16M 11/10
USPC 248/122.1

(57) ABSTRACT

The present invention relates generally to a mounting assembly to secure a cellular phone, tablet, or other electronic device. The mounting assembly has channels that secure the electronic device by the edges, allowing unobstructed access to the touch screen and camera lens of the electronic device, such as a typical cellular phone or tablet. The mounting assembly contains an attachment mechanism that connects to a base and that also provides the ability to adjust the orientation of the electronic device. The mounting assembly allows hands-free operation of the electronic device.

### CROSS REFERENCE TO RELATED APPLICATIONS

This application claims priority under 35 U.S.C. §119 to U.S. Patent Application No. 61/834,932, entitled ELECTRONIC DEVICE MOUNTING ASSEMBLY, filed Jun. 14, 2013, the disclosure of which is incorporated herein by reference in its entirety.

### BACKGROUND OF INVENTION

1. Field of Invention

The following disclosure relates generally to a mounting assembly used to secure a cellular phone, electronic tablet, digital camera, or other electronic device for attachment to another object. An electronic device secured in the mounting assembly is attached to a harness, helmet, piece of equipment, vehicle, or any other object allowing hands-free viewing and operation of the device.

2. Description of Related Art

Users of electronic devices often find themselves in situations where hands-free access to the device is necessary. For example, a bicyclist may want to view GPS directions or utilize other functions of his electronic device while riding, requiring the electronic device to be visible to the rider. To accomplish this task, a bicyclist may use a mounting assembly to attach a cellular phone to the bicycle's handlebars, allowing the bicyclist to view GPS directions displayed on the phone's screen.

Previously disclosed mounting assemblies have been used to secure electronic devices to an object to allow hands-free access. In one example, a mounting assembly is a plastic snap-on device that covers almost the entirety of one side of the device. By covering one side of the electronic device, the mounting assembly prevents the user from accessing the touch screen on the front side of the cellular phone during video recording use, or obscures the camera lens when mounted for touch screen operations. Given this design, during video recording use the user cannot view the video or access the camera controls on the touch screen as the video is being recorded without removing the device from the mounting assembly. Moreover, because the mount is a snap-on fitting, it must be sized for specific phones to ensure a tight fit. Other mounting assemblies have also been disclosed that totally encase the electronic device. As with previous examples of mounting assemblies, the cases are sized for a specific device and lack the ability to accept electronic devices of differing sizes. The present invention overcomes these obstacles by mounting the device in a manner that allows both the touch screen and camera lens to remain accessible and by being adjustable to mount different size devices.

### BRIEF SUMMARY OF INVENTION

One embodiment of the invention relates to a mounting assembly used to secure a cellular phone, tablet, or other electronic device to another object. The mounting assembly secures the electronic device in two channels that engage edges of the electronic device. Once the electronic device is secured, the mounting assembly is then attached to a harness, helmet, person, dashboard of a car, desk, or any other object desired by the user.

The mounting assembly secures the electronic device in a manner that allows a built-in camera and the device's touch screen to remain unobstructed. Common electronic devices are designed with a touch screen on the front side of the device and a camera on the back side. Given this design, the mounting assembly of the present invention secures the device on its edges to provide unobstructed access to both sides of the device. Also, given the varying size and shape of popular electronic devices and the use of protective cases, the mounting assembly adjusts to accept many devices of differing width, length, and thickness.

Additionally, one embodiment of the mounting assembly of the present invention has an attachment mechanism that allows a user to affix the electronic device to a variety of interchangeable bases. The bases are adapted to secure the entire mounting assembly to a bicycle, vehicle, person, helmet, or other object. The attachment mechanism further allows a user to selectively adjust the angle, in one direction, between the electronic device and the object to which it is attached. In a second direction, the attachment mechanism pivots to allow a user to rotate the electronic device while it is still secured in the mounting assembly. In other words, the attachment mechanism provides two degrees of freedom for the mounting assembly.

### BRIEF DESCRIPTION OF THE SEVERAL VIEWS OF DRAWINGS

FIG. 1 depicts a partial view of an embodiment of the invention with a cellular phone secured in the mounting assembly.

FIG. 2 is another view of the mounting assembly as depicted in FIG. 1.

FIG. 3 is depicts another embodiment of the mounting assembly.

FIG. 4 is another view of the mounting assembly shown in FIG. 1.

FIG. 5 is another view of the mounting assembly shown in FIG. 3.

FIG. 6 depicts another embodiment of the mounting assembly.

FIG. 7 depicts another embodiment of the mounting assembly with an adjustable base.

FIG. 8 shows another embodiment of the mounting assembly having a quick-release fastener.

FIG. 9 shows an adapter for the mounting assembly.

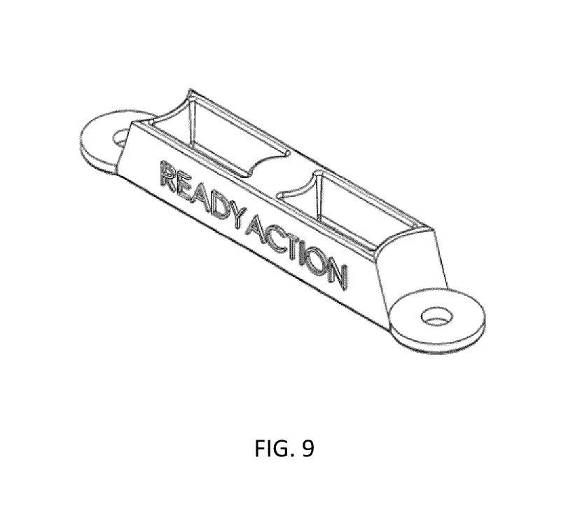

FIG. 10 shows the mounting assembly with a base that can be worn by a user.

### DETAILED DESCRIPTION OF THE INVENTION

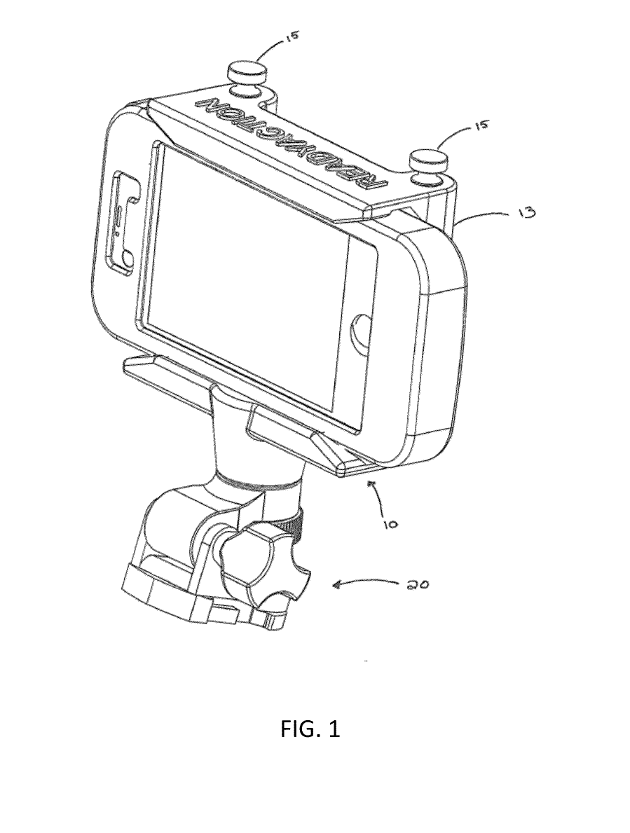

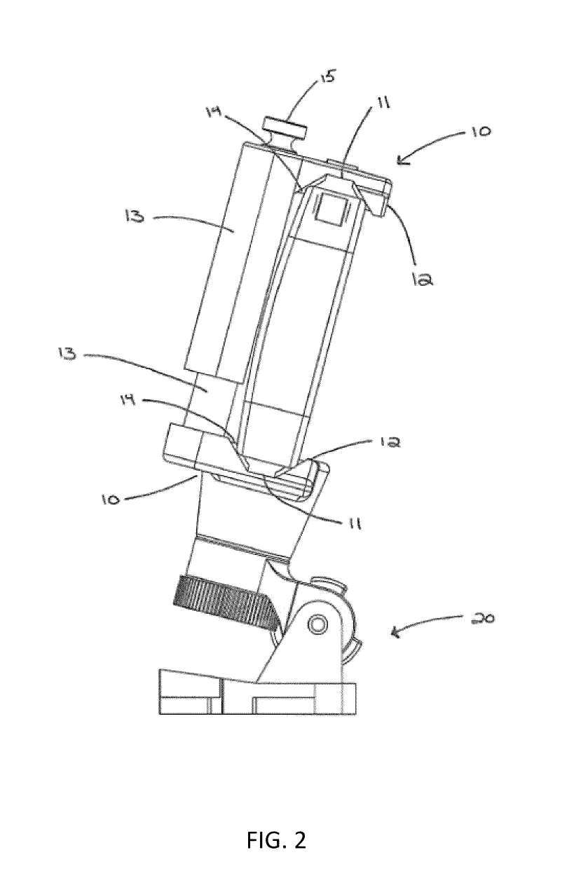

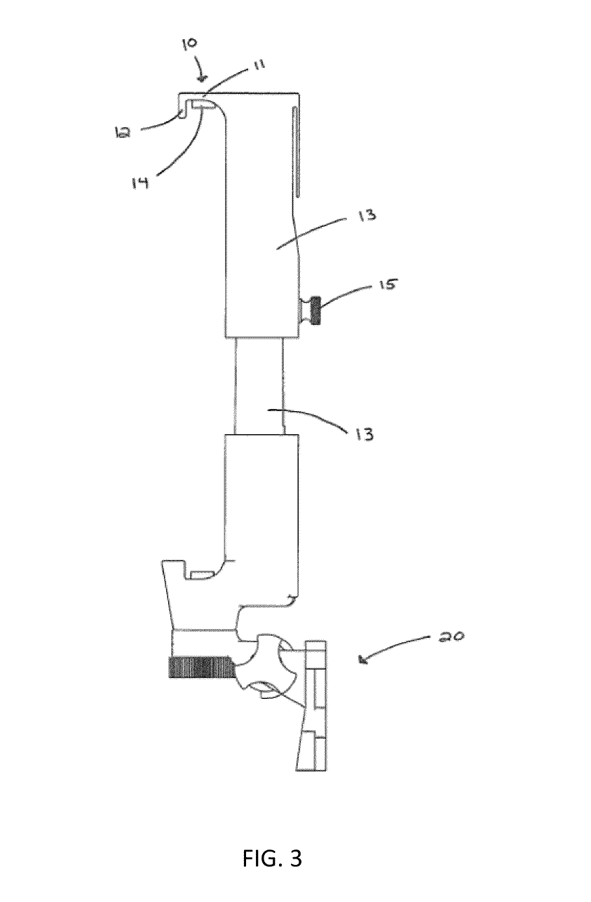

The present invention relates to a mounting assembly used to secure an electronic device. The electronic device can be a cellular phone, electronic tablet, e-reader, GPS receiver, digital audio player, or any other portable electronic device. In the preferred embodiment of the present invention, the mounting assembly has two channels 10, disposed in a parallel orientation to each other. As shown in FIG. 1, the channels 10 engage the outer edges of an electronic device that is generally rectangular in shape. The mounting assembly can secure an electronic device of any shape if the device has two opposing edges that are relatively straight and substantially parallel. In one embodiment, the channels 10 have a center surface 11 and two adjacent side surfaces 12, wherein the center surface 11 of the channel 10 is substantially flat, as shown in FIG. 2. Each of the side surfaces 12 form an obtuse angle at its intersection with the center surface 11. That is, the center surface and adjacent side surfaces form a ‘V’ shape. It is not necessary for the device to contact the center surface 11 of the channel 10 having a ‘V’ shaped profile to be secured. As can be seen in both FIG. 1 and FIG. 2, the side surfaces 12 slightly overlap the edge of the electronic device and prevent the device from moving in a direction perpendicular to the length of the channel 10. In alternate embodiments, as shown in FIG. 3, the channels 10 are U-shaped and the side surfaces 12 form a right angle with the center surface 11. In any of the embodiments, when the electronic device is placed in the mounting assembly, the channels substantially encompass the edge of the electronic device across its width.

In the preferred embodiment, the length of the channels 10 is substantially the length of the electronic device, which is depicted in FIG. 1. However, the channels 10 may be shorter or longer than the electronic device, depending on the length of the device, and still provide sufficient support since the user can adjust the force exerted by the channels on the edge of the phone. To allow devices to extend pass the end of the channels 10, the ends are left open, as depicted in FIG. 3. In other words, a plane defined by the ends of the center surface 11 and side surfaces 12 of the channel is not enclosed or covered. Otherwise, if the ends of the channels 10 were closed, the mounting assembly would only be capable of securing an electronic device that was equal to or shorter than the length of the channels 10.

With the ends of the channels 10 open, the mounting assembly relies on friction between the edge of the electronic device and the channels 10 to prevent the device from sliding along a line parallel to the length of the channels 10. That is, a friction fit is created at the junction between the channels 10 and the electronic device. In alternate embodiments of the present invention, the channels 10 are lined with a non-slip material to increase the static friction between the electronic device and the channels 10. As shown in FIG. 2, a strip 14 on non-slip material is disposed along the length of the side surfaces 12 of the channels 10. In a U-shaped channel, the non-slip strips 14 are disposed on the center surface 11 of the channels 10. In yet another embodiment, non-slip strips 14 can be place on all surfaces of the channels 10. The strips 14 are attached to the channels 10 with an adhesive. A person having skill in the art will appreciate that a variety of materials can be used for the non-slip strips 14, such as rubber, foam, polymers, or other similar materials.

When an electronic device is secured in the mounting assembly, each of the channels 10 are held in fixed position, which is adjustable, by at least one fastener 15 connecting each of the channels 10. A person having ordinary skill in the art will appreciate that any type of mechanical fastener can be used to hold the channels 10 in a fixed position. In the preferred embodiment, the fastener 15 is a screw having a threaded body and a head.

As shown in FIG. 1, a set of screws clamps the electronic device between the two channels 10. By turning the fasteners 15 in one direction, the channels 10 are drawn towards each other and the clamping force is increased, securing the electronic device in the mounting assembly. By turning the fasteners 15 in the opposite direction, the channels 10 can be separated and the electronic device is released from the mounting assembly.

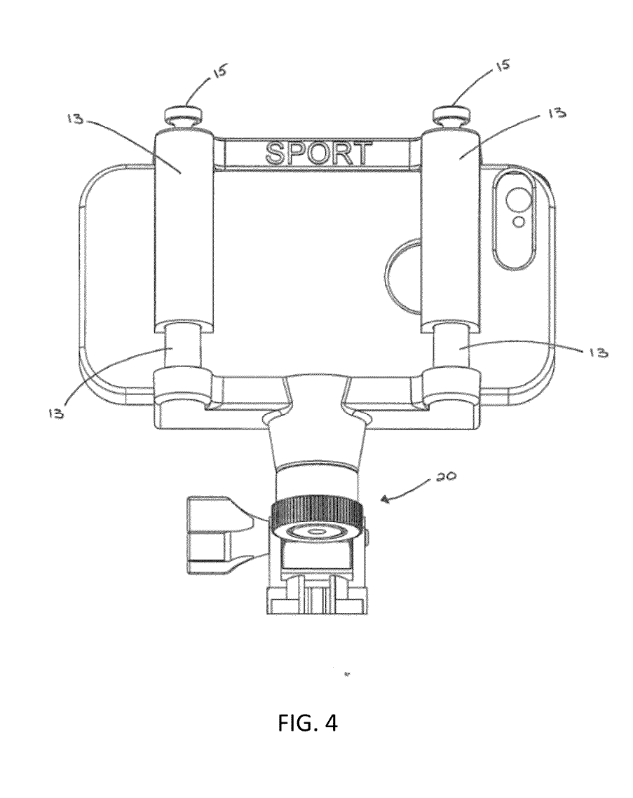

In the preferred embodiment, a set of screws are positioned at each end of the channels 10 in an extension 13. As shown in FIG. 4, an extension 13 protrudes from both ends of the channels 10. The extensions 13 on a first channel 10 are hollow to allow the fastener 15 to pass through the length of the extension 13. The top of the fastener 15 contacts the top of the extensions 13 on the first channel 10 to prevent the fastener 15 from passing all the way through the extensions 13. For example, in the preferred embodiment, the body of the screw is contained within the interior of the extensions 13 of a first channel and the head of the screw contacts the top of the extension 13. Consequently, the hole allowing the body of the screw to enter the extension 13 has a smaller diameter than the diameter of the screw head.

The extensions 13 on a second channel 10 contain a portion adapted to receive the fastener 15. In the preferred embodiment, a threaded insert is placed in the ends of the extensions 13 of the second channel. The threaded insert engages the body of the screw passing through the extensions 13 of the first channel 10. The threads of the screw do not engage the extensions 13 of the first channel 10, allowing the channels 10 to be drawn together as the screws are tightened. When the screws are loosened, the channels 10 can be moved apart by the user since the head of the screw is no longer exerting a force on the top of the extensions 13 of the first channel 10. Consequently, the fasteners 15 can be adjusted to accommodate electronic devices of varying widths, where the range of adjustment is proportionate to the length of the fastener. To prevent the screws from being completely removed from the extensions 13, a bushing is placed on the body of the screw. The bushing is not threaded and allows the screw to turn freely, but resists the screw from sliding out of the extension 13 of the first channel 10.

The extensions 13 of channels 10 further serve to keep the two opposing channels 10 aligned in a parallel orientation to each other. In one embodiment, as shown in FIG. 4, the extension 13 of the second channel 10 is cylindrical in shape and substantially the diameter of an opening in the bottom of the extensions 13 of the first channel 10, which is also cylindrical in shape. In this embodiment, the extensions 13 of the second channel 10 are located within the hollow of the extensions 13 of the first channel 10. This configuration allows a telescoping action of the extensions 13 and keeps the cylindrical extensions 13 concentric.

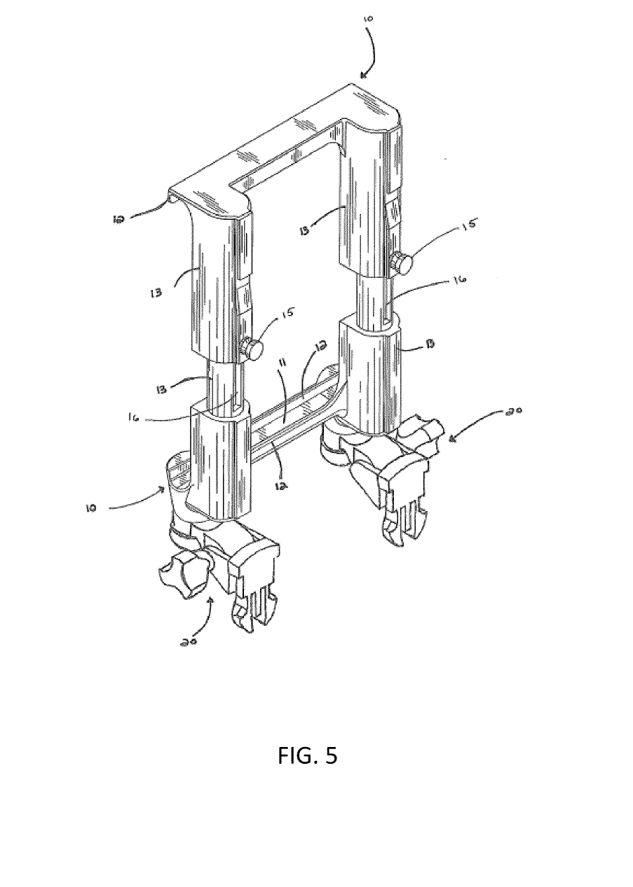

In an alternative embodiment, fasteners 15 are disposed on the rear of the mounting assembly, as shown on FIG. 5. In this embodiment, s screw passes through an opening in the extensions 13 of the first channel 10, wherein the opening is large enough to accommodate the body of the screw but smaller than the diameter of the head of the screw. The body of the screw engages a nut or threaded insert disposed in the interior of the extensions 13 of the second channel 10. By tightening the screws, the extensions 10 of both channels 10 are forced together, creating static friction between the extensions 13 to prevent movement. To adjust the distance between the two channels 10, a user manually slides the channels 10 to the correct position then tightens the screws to fix the channels 10 in position, rather than continuing to tighten the screws. To remove an electronic device, the screws or other fasteners are loosened and the channels are manually separated.

To allow a full range of adjustment, in this embodiment a slot 16 is created on the extensions 13 of the second channel 10. The width of the slot 16 is substantially the size of the body of the screw or fastener 15. The threaded insert, on the other hand, is larger than the slot 16 to prevent it from pulling through the slot 16. When the fastener 15 is tightened, the threaded insert is forced against the interior of the extensions 13 of the second channel 10. When the fastener 15 is loosened, the threaded insert is able to slide freely along the inside of the extension 13 of the second channel 10.

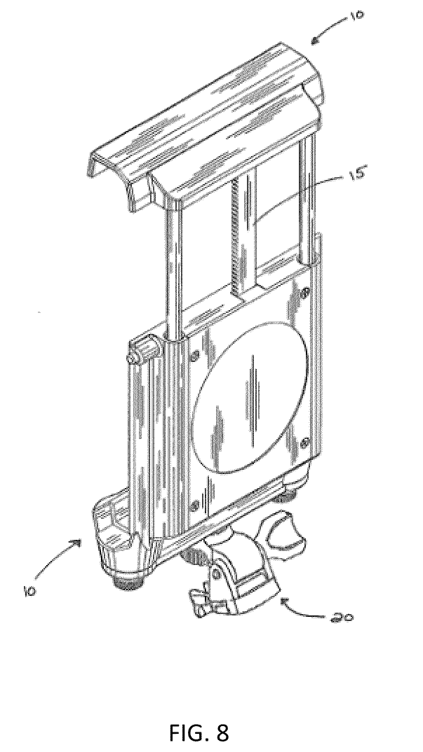

In yet another embodiment, the fastener 15 is a ratchet-like device. As shown in FIG. 8, a set of teeth is disposed on an extension 13 of a first channel 10. A pawl is located on an extension 13 on the second channel 10 that spans the width of the channel 10. The pawl only allows the channels 10 to be moved closer together, securing the electronic device. When the pawl is released from the teeth, the channels 10 can be separated to remove the device.

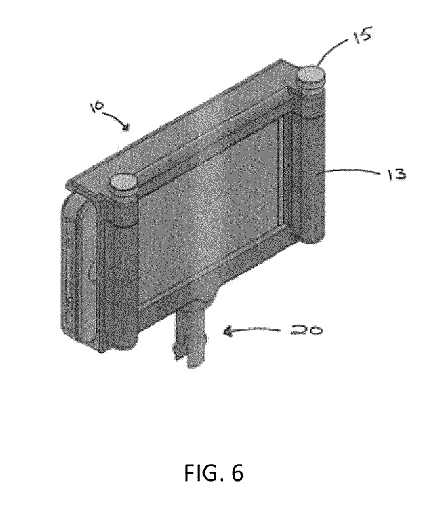

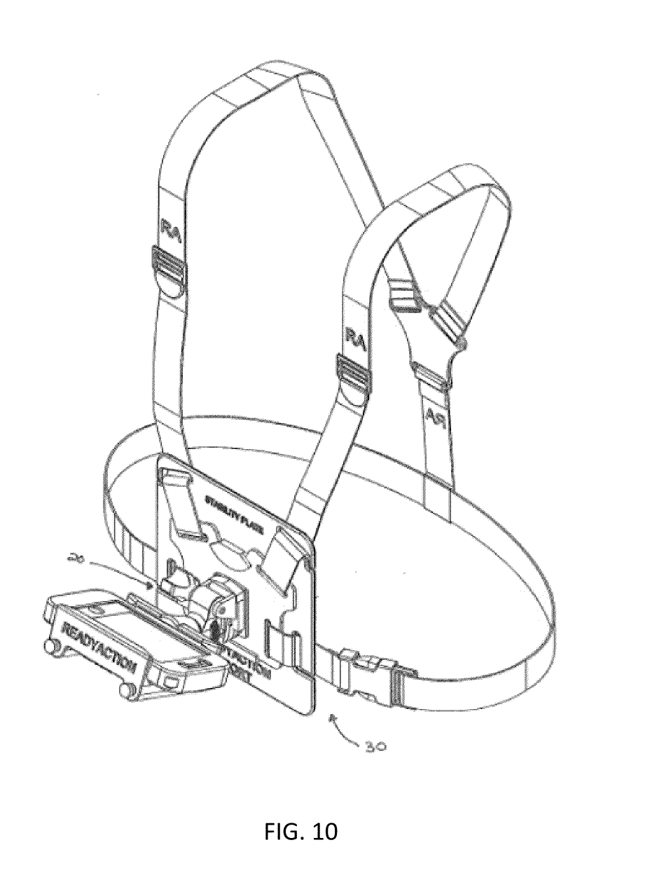

In order to mount the electronic device to another object, an attachment mechanism 20 extends from at least one of the channels 10 and connects the parts of the mounting assembly to a base 30. FIG. 10 shows an example of a mounting assembly including a base 30, wherein the base is a plate and harness used to allow a user to wear the mounting assembly. The base 30, by way of further example, can be a suction cup that is mounted to a windshield of a car, a clamp that attaches to the handlebars of a bike or ski pole, or an adhesive-backed plate that is stuck to a helmet or other solid surface. In the preferred embodiment, the attachment mechanism is a buckle adapted to mate with various bases 30, wherein the attachment mechanism 20 includes a thumb screw for being secured to the channel 10. The attachment mechanism 20 is connected to the channel 10 near its midpoint and extends from a surface of the channel 10 opposite from the center surface 11. That is, the attachment mechanism 20 extends from the bottom side of a channel 10, where the top side is in contact with the electronic device. The location of the attachment mechanism 20 relative to the channel is depicted in FIG. 4. In an alternative embodiment, the attachment mechanism 20 is a post that is inserted into a corresponding receiver on the base, which is shown on FIG. 6.

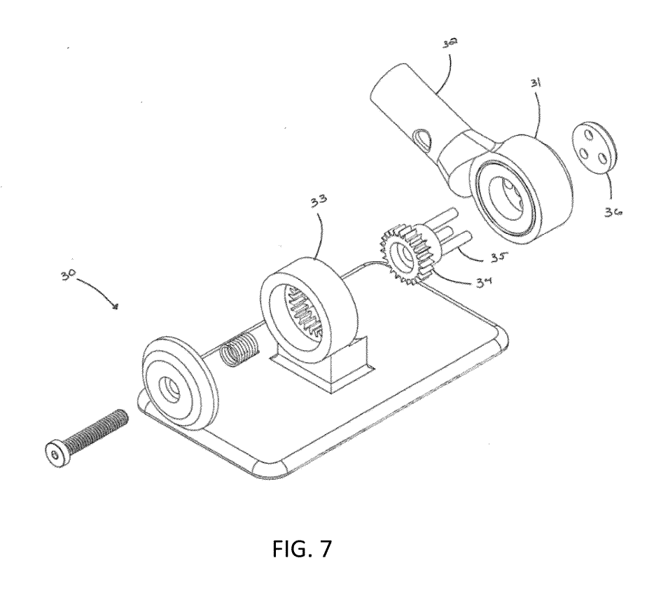

In one embodiment, as shown in FIG. 7, a base 30 is comprised of a first circular joint 31, which is attached to a receiver 32 adapted to mate with the attachment mechanism 20, and a second circular joint 33, which is fixed to a base plate. A set of gear teeth are disposed on the inner circumference of the second circular joint 33. A cogwheel 34 meshes with the teeth of the second circular joint 33 and is contained on each side by each of the circular joints. The cogwheel 34 further contains rods 35 extending from one of its sides. The rods 35 align with holes on the first circular joint 31. When the rods 35 pass through the holes on the first circular joint 31, the teeth of the cogwheel 34 are meshed with the gear teeth on the second circular joint 33, preventing rotation between the two circular joints. A cap 36 is provided on one side of the first circular joint 31 to allow the rods 35 to be depressed and disengaged from the holes of the first circular joint 31. As a result of depressing the cap 36, the cogwheel 34 is pushed past the teeth of the second circular joint 33 into a cavity contained adjacent to the gear teeth, allowing free rotation between the two circular joints. After the cap 36 is released, a spring located adjacent to the cogwheel 34 pushes the cog 34 back into engagement with the teeth of the second circular joint 33, preventing rotation.

In the preferred embodiment, the channels, extensions, attachment mechanism, and base are constructed of ABS plastic and are formed by an injection molding process. The screw or fastening member is made of metal, such as brass. A person having ordinary skill in the art will appreciate that any combination of materials can be used for the mounting assembly, depending on the desired characteristics of the mounting assembly, such as weight or strength.

The invention claimed is:

1. A mounting assembly used to secure an electronic device, comprising:
a first channel and a second channel, wherein the first channel is substantially parallel to the second channel;
an extension disposed on each of the first channel and the second channel, wherein the extension of the first channel contacts the extension of the second channel;
a fastener adapted to hold the first channel in a fixed position relative to the second channel;
an attachment mechanism extending from at least one of the first channel and the second channel.

2. The mounting assembly of claim 1 further comprising
a base affixed to the attachment mechanism.

3. The mounting assembly of claim 1 wherein each of the first channel and the second channel has a center surface and two side surfaces adjacent to the center surface.

4. The mounting assembly of claim 3 wherein each of the side surfaces form a right angle with the center surface.

5. The mounting assembly of claim 3 wherein each of the side surfaces form an obtuse angle with the center surface.

6. The mounting assembly of claim 1 wherein a non-slip material is disposed on each of the first channel and the second channel.

7. The mounting assembly of claim 1 further comprising:
an aperture through the length of the extension of the first channel;
a insert disposed on the extension of the second channel, wherein the insert is adapted to mate with the fastener;
wherein a portion of the fastener passes through the aperture of the extension of the first channel and engages the insert.

8. The mounting assembly of claim 1 further comprising:
an aperture passing through a side of the extension of the first channel;
a slot along the length of a side of the extension of the second channel;
an insert located in the slot of the extension of the second channel, wherein the insert has width greater than the width of the slot and is adapted to mate with the fastener; and
wherein the fastener passes through the aperture of the extension of the first channel and passes through the slot of the extension of the second channel to engage the insert.

9. The mounting assembly of claim 2 further comprising:
an adapter disposed between the attachment mechanism and the base.

10. The mounting assembly of claim 2 wherein the base is comprised of:
a first circular joint;
a second circular joint having an interior circumference and an exterior circumference, wherein teeth are disposed on the interior surface;
a plate affixed to the exterior circumference of the second circular joint;
a cogwheel having teeth and extensions, wherein the teeth engage the teeth of the second circular joint and the extensions are adapted to engage the first circular joint; and
a fastener adapted to affix the second circular joint to the first circular joint, wherein the cogwheel is encased between the first circular joint and the second circular joint.
